(19) United States
(12) Patent Application Publication
(10) Pub. No.: US 2010/0047585 A1
(43) Pub. Date: Feb. 25, 2010

(54) PROCESS FOR REMOVING FLUORINATED EMULSIFIER FROM FLUOROPOLYMER DISPERSIONS USING AN ION-EXCHANGE RESIN AND DISPERSIONS OBTAINED THEREFROM

(76) Inventors: Klaus Hintzer, Kastl (DE); Michael C. Dadalas, Eggenfelden (DE); Andreas R. Maurer, Langenneufnach (DE); Tilman C. Zipplies, Bughausen (DE)

Correspondence Address: 3M INNOVATIVE PROPERTIES COMPANY, PO BOX 33427, ST. PAUL, MN, 55133-3427, US

(21) Appl. No.: 12/519,220

(22) PCT Filed: Dec. 12, 2007
(86) PCT No.: PCT/US07/87210

§ 371 Date: Jun. 15, 2009

(30) Foreign Application Priority Data
Dec. 15, 2006 (GB) 0625071.6

(51) Int. Cl. B32B 27/08; C08L 27/18

(52) U.S. Cl. 428/421; 525/326.2

(57) ABSTRACT

The present invention provides a process for reducing the amount of fluorinated emulsifier in fluoropolymer dispersions by contacting the fluoropolymer dispersion with an anion exchange resin in the presence of amphoteric surfactants or anionic surfactants of low molecular weight and provides fluoropolymer dispersions containing low amounts of fluorinated emulsifier and no or only low amounts of non-ionic surfactants.

The present invention relates to a process for reducing the amount of fluorinated emulsifier in fluoropolymer dispersions using ion exchange resins and ionic surfactants. The invention also relates to fluoropolymer dispersions containing ionic surfactants and no or only low amounts of non-ionic surfactants and fluorinated emulsifiers.

Fluoropolymers, that is, polymers having a fluorinated backbone, have been long known and used in a various applications because of their desirable properties such as heat resistance, chemical resistance, weatherability, UV-stability etc. . . . Various fluoropolymers are for example described in “Modern Fluoropolymers”, edited by John Scheirs (ed), Wiley Science 1997. The fluoropolymers may have a partially fluorinated backbone, generally at least 40% by weight fluorinated, or a fully fluorinated backbone. Particular examples of fluoropolymers include polytetrafluoroethylene (PTFE), copolymers of tetrafluoroethylene (TFE) and hexafluoropropylene (HFP) (FEP), perfluoroalkoxy copolymers (PFA), ethylene-tetrafluoroethylene (ETFE) copolymers, terpolymers of tetrafluoroethylene, hexafluoropropylene and vinylidene fluoride (THV) and polyvinylidene fluoride polymers (PVDF).

The fluoropolymers may be used to coat substrates to provide desirable properties thereto such as for instance chemical resistance, weatherability, water- and oil repellence etc. . . . For example, aqueous dispersions of fluoropolymer may be used to coat kitchen ware, to impregnate fabrics, such as textiles or glass fibers or to coat paper or polymeric substrates.

A frequently used method for producing aqueous dispersions of fluoropolymers involves aqueous emulsion polymerization of one or more fluorinated monomers usually followed by a concentration step to increase the content of solids in the raw dispersion obtained after emulsion polymerization. The aqueous emulsion polymerization of fluorinated monomers generally involves the use of a fluorinated emulsifier. Frequently used fluorinated emulsifiers include perfluorooctanoic acids and salts thereof, in particular ammonium perfluorooctanoic acid. Further fluorinated emulsifiers used include perfluoropolyether surfactants such as those disclosed in EP 1059342, EP 712882, EP 752432, EP 816397, U.S. Pat. No. 6,025,307, U.S. Pat. No. 6,103,843 and U.S. Pat. No. 6,126,849. Still further emulsifiers that have been used are disclosed in U.S. Pat. No. 5,229,480, U.S. Pat. No. 5,763,552, U.S. Pat. No. 5,688,884, U.S. Pat. No. 5,700,859, U.S. Pat. No. 5,804,650, U.S. Pat. No. 5,895,799, WO 00/22002 and WO 00/71590.

Most of these fluorinated emulsifiers have a low molecular weight, that is, a molecular weight of less than 1000 g/mol. Fluorinated emulsifiers are generally expensive compounds and in several cases fluorinated emulsifiers have been found not to be biodegradable. Accordingly, measures have been taken to minimize the amount of fluorinated low molecular weight emulsifiers in aqueous fluoropolymer dispersions.

WO 00/35971 describes a method in which the amount of fluorinated emulsifier is reduced by contacting the fluoropolymer dispersion, obtained by emulsion polymerization, with an anion exchange resin. From about 0.5 to about 15% by weight, preferably from about 1% to about 5% by weight based on the weight of the dispersion of non-ionic surfactants are added to the aqueous dispersion to stabilize the dispersion while being in contact with the anion exchange resin.

In certain commercial applications of fluoropolymer dispersions, it may be desired to avoid or reduce the presence of non-ionic surfactants. For example, it has been observed that non-ionic surfactants may lead to the formation of smeary films on the surface of coatings prepared from fluoropolymer dispersions containing non-ionic surfactants, in particular when the preparation of the coating involves heating steps at moderate temperatures, that is, in temperature ranges from about 60 to about 250° C. These temperatures ranges, for example, play a role in processes where fluoropolymer dispersions are used for coating temperature-sensitive substrates such as paper, textiles or heat-sensitive fabrics or the fluoropolymer itself or the fluoropolymer containing coating composition has a low decomposition temperature, for example, a decomposition temperature below 260° C., or preferably below 200° C. Typically, the heat-sensitive substrate to be coated is submerged in the fluoropolymer prior to being submitted to a subsequent drying step at moderate temperatures. It is believed that the application of these temperatures could lead to a separation of the non-ionic surfactant from the polymers and to a migration of the surfactants to the surface. The temperature range may be too low for complete degradation of the non-ionic surfactants. Removal of the non-ionic surfactants from the films is difficult or expensive as it may involve, for example, heat treatments for periods of greater than 12 hours or even greater than 24 hours to sufficiently remove the non-ionic surfactants by evaporation.

In other applications, in particular those where fluoropolymers or fluoropolymer containing composite materials are used to create a hard and resistant surface (for example, materials for coating bearings or sliding surfaces), the fluoropolymer is separated from the dispersion by coagulation. Non-ionic surfactants are usually not deactivated and their interaction with humidity may lead to a softening of the coating.

Therefore, there would be a desire to provide a process for removing fluorinated emulsifiers from fluoropolymer dispersions where the use of non-ionic surfactants is not mandatory but still leads to stabilized dispersions. Alternatively there is a desire for a process that avoids or reduces the use of non-ionic surfactants but still leads to stabilized dispersions. There would also be a need to provide fluoropolymer dispersions containing no or only small amounts of fluorinated emulsifiers and no or only small amounts of non-ionic surfactants.

WO03/020836 discloses a process where fluorinated emulsifiers are removed from fluoropolymer dispersions by anion exchange resins in the presence of between about 1 and 12% by weight based on the solid content in the dispersion of non-ionic surfactants. The resulting dispersions may additionally contain non-fluorinated anionic surfactants (10 to 5,000 ppm based on solid content).

EP 1 676 868 A1 describes a process of removing fluorinated emulsifiers from fluoropolymer dispersions wherein non-fluorinated anionic emulsifiers are added to the dispersion prior to submitting the dispersion to an ion-exchange resin. The resulting dispersion contains dispersed fluoropolymer, anionic surfactants and no, or only little fluorinated emulsifier. According to EP 1 676 868 A1 the purified dispersions, that is, the dispersions containing no, or only little fluorinated emulsifier were only stable if the non-fluorinated anionic surfactant has a high molecular.

However, the use of anionic surfactants having high molecular weight is costly. Additionally, high molecular weight surfactants are difficult to remove from the dispersion or articles treated with the dispersion, for example by thermal treatment, in particular by thermal treatment at moderate temperatures.

Accordingly, it would now be desirable to find a process for removing fluorinated emulsifiers from aqueous fluoropolymer dispersions that avoids or reduces the use of non-ionic surfactants. In particular, it is desirable to provide a process employing surfactants that do not form smeary films on fluoropolymer coatings upon treatment at moderate temperatures. Additionally, it would be desirable to provide a process that is economic or that allows to employ commercially readily available surfactants. Preferably, the process is economically attractive even when practiced at an industrial scale. Furthermore, it would be desirable to provide a stabilized fluoropolymer dispersion containing no or only low amounts of non-ionic surfactants and fluorinated emulsifiers.

It has been found that fluorinated emulsifiers may be removed from the fluoropolymer dispersion by contacting the dispersion with an anion exchange in the presence of anionic or amphoteric surfactants. The use of non-ionic surfactant is optional in this process and hence the process can be used to produce dispersions that are low in fluorinated emulsifier content and have no or only little non-ionic surfactant content.

Furthermore, it has also been found that fluorinated emulsifiers may be removed from fluoropolymer dispersions in the presence of only low amounts of non-ionic surfactants or even in the absence thereof using anion exchange resins that have been loaded with anionic and/or amphoteric surfactants.

In one aspect there is provided a process of reducing the amount of fluorinated emulsifier in a fluoropolymer dispersion, said process comprising the step of contacting the dispersion with an anion exchange resin that has been loaded with the anionic and/or amphoteric surfactant prior to being contacted with the dispersion and wherein the anionic and/or amphoteric surfactant is preferably not fluorinated.

In another aspect there is provided a process of reducing the amount of fluorinated emulsifier in a fluoropolymer dispersion, said process comprising the step of contacting the dispersion with an anion exchange resin in the presence of a non-fluorinated ionic surfactant, wherein the ionic surfactant is either an amphoteric surfactant or an anionic surfactant and wherein the non-fluorinated ionic surfactant is present in the dispersion, prior to or during the dispersion being contacted with the anion exchange resin, in an amount that exceeds the amount of non-fluorinated ionic surfactant that can be taken up by the resin.

Furthermore, there is provided an aqueous fluoropolymer dispersion comprising:
a) from about 5% to about 35% by weight based on the weight of the dispersion of a fluoropolymer,
b) less than about 0.02% by weight based on the solid content of the dispersion of fluorinated emulsifier,
c) from at least about 0.02% by weight based on the solid content of the dispersion of a non-fluorinated ionic surfactant, wherein the ionic surfactant is an amphoteric surfactant or an anionic surfactant and wherein the anionic surfactant has a molecular weight of less than 600 g/mol, and
d) less than about 0.5% by weight based on the solid content of non-ionic surfactants.

Additionally there is provided an aqueous fluoropolymer dispersion comprising:
a) from about 35% to about 70% by weight based on the weight of the dispersion of a fluoropolymer,
b) less than about 0.02% by weight based on the solid content of the dispersion of fluorinated emulsifier,
c) from at least about 0.02% by weight based on the solid content of the dispersion of a non-fluorinated ionic surfactant, wherein the ionic surfactant is an amphoteric surfactant or an anionic surfactant and wherein the anionic surfactant has a molecular weight of less than 600 g/mol, and
d) less than about 0.5% by weight based on the solid content of non-ionic surfactants.

There is also provided the use of the fluoropolymer dispersions as described above for coating or impregnating a substrate at a temperature from about 60 to about 250° C.

Furthermore, there is also provided the use of the fluoropolymer dispersions as described above in coating compositions that degrade at a temperature below 260° C.

Additionally, there is provided the use of the fluoropolymer dispersions in coating of substrates involving coagulation of the fluoropolymer dispersion.

There is also provided, the use of the fluoropolymer dispersions as described above for coating bearings.

### The Ionic Surfactant

Suitable ionic surfactants may be anionic or amphoteric surfactants or mixtures thereof. Amphoteric surfactants contain both anionic and cationic groups. Suitable amphoteric surfactants are those that behave substantially like anionic surfactants at the pH of the fluoropolymer dispersion, that is, the anionic groups are substantially deprotonated.

Typically, the surfactant is capable of stabilizing the dispersion when the dispersion is submitted to the anion-exchanger, that is, it reduces or avoids coagulation or precipitation of the fluoropolymer on the resin. Therefore, an ionic surfactant is chosen that binds weaker to the anion-exchanger than the fluorinated emulsifier contained in the fluoropolymer dispersion. The optimal amount of surfactant may be identified by routine experimentation.

The ionic surfactant is a low molecular weight surfactant. Low molecular weight anionic surfactants have a molecular weight of equal to or less than about 600 g/mol, preferably less than or equal to about 350 g/mol, more preferably equal to or less than about 300 g/mol. Low molecular weight amphoteric surfactants may have a molecular weight of less than 1500 g/mol, or less than 600 g/mol, preferably equal to or less than 350 g/mol or equal to or less than 300 g/mol.

Typically, the ionic surfactant comprises one or more ionic group and a non polar chain. The ionic groups may be situated at the head or the centre of the molecule, or several ionic groups may be situated opposite at each other, for example at head and tail of the molecule.

Preferably, the ionic surfactant contains no more than two anionic groups, more preferably only one anionic group per molecule.

The amphoteric surfactant according to the invention may contain one, two or more than two anionic and cationic groups. Preferably, the amphoteric surfactant may not contain more than one cationic group or anionic group.

Typical cationic groups include, for example, ammonium or substituted ammonium groups, such as alkyl, dialkyl or trialkylammonium groups.

Typical anionic groups include, for example, carboxylates, sulphates, sulphonates, phosphates and phosphonates.

The ionic surfactant according to the invention may also comprise non-ionic groups, such as, for example, one or more ester or ether group(s), for example one or more polyethylenglycol group(s), one or more —CONH—, —CONH₂ or —CONRR′ group(s), wherein R and R′ represent identical or different alkyls or wherein R or R′ may be hydrogen.

The non-polar residue of the ionic surfactant may be, for example, saturated or non-saturated, linear or branched alkyls, alkylaryls, alkyl or aryl ether or silicones. Preferred surfactants are surfactants based on branched or linear or cyclic alkyl residues, preferably alkyl residues comprising more than 8 and less than 30, more preferably more than 10 and less than 20, most preferably between 12 and 18 C atoms.

Typical examples of anionic surfactants that may be used according to the invention include alkyl (such as C₈ to C₂₀, preferably C₁₂-C₁₈ alkyl) sulfonates, such as lauryl sulfonate, alkyl (such as C₈ to C₂₀, preferably C₁₂-C₁₈ alkyl) sulfates, such as lauryl sulfate, alkylarylsulfonates, fatty acids, such as lauric acids, phosphoric acid alkyl or alkylaryl ester and salts thereof. Other suitable anionic non-fluorinated surfactants include silicone-based surfactants having pending anionic groups such as phosphoric acid groups, carboxylic acid groups, sulfonic acid groups, sulphuric acid groups and salts thereof as well as mixtures thereof.

Other examples include laureth sulphates, laureth citrates, laureth phosphates, laureth sulfosuccinates, laureth acetates, lauryl phosphates, lauryl sulfates, lauryl sulfosuccinates, lauryl sulfoacetates, lauryl sulfonates, C₁₂₋₁₅ pareth sulfates, C₁₂₋₁₅ pareth phosphates, C₁₂₋₁₅ pareth sulfosuccinates, decyl sulfates, stearates, capryleth sulfates, nonoxynol sulfates, nonoxynol sulfosuccinates, nonoxynol phosphates, nonoxyl sulfates, octyl sulfates, octyl phosphates, oleic sulfates, oleic sulfonates, oleyl sulfates, stearoyl lactylates, C₉₋₁₅ alkyl phosphates, capryleth carboxylic acids, ceteareth phosphates, cetyl phosphates, cumene sulfonic acid, cyclocarboxypropyloleic acid, oleth phosphates, oleth sufosuccinates, deceth phosphates, dicyclohexyl sulfosuccinates, dihexyl sulfosuccinates, diisobutyl sulfosuccinates, diisodecyl sulfosuccinates, diisohexyl sulfosuccinates, dioctyl sulfosuccinates, diisodecyl sulphosuccinate, Na salt (Emulsogen SF 8), diisodecyl sulphosuccinate, Na salt+isopropylalcohol (Emulsogen SB10), dilaureth citrates, dilaureth phosphates, stearyl sulfosuccinamates, 2-ethylhexyl phosphate, glyceryl stearates, glycol dilaurates, glycol dioleates, glycol distearates, glycol laurates, glycol oleates, glycol stearates, isosteareth phosphates, laureth-12 carboxylic acid, oleyl/cetyl sulfates, PEG(polyethylene glycol)-2 dilaurates, PEG-2 dioleate, PEG-2 distearate, PEG-2 laurate, PEG-2 oleate, PEG-9 stearamide carboxylic acid, PEG-2 stearate, lauroyl sarcosinate, propylene glycol laurate, propylene glycol oleate, propylene glycol stearate, sodium C₁₃₋₁₇ alkane sulfonate, sodium C₈₋₁₀ alkyl sulfate, sodium C₉₋₁₄ alkyl sulfate, sodium C₁₂₋₁₃ alkyl sulfate, sodium C₁₂₋₁₄ alkyl sulfate, sodium C₁₂₋₁₅ alkyl sulfate, sodium C₁₂₋₁₈ alkyl sulphate, sodium C₉₋₂₂ alkyl sec sulfonate, sodium C₁₄₋₁₇ alkyl sec sulfonate (HOSTAPUR SAS 30), cetearyl sulfates, cetyl/oleyl sulfates, sodium C₁₄₋₁₆ olefin sulfonate (POLYSTEP A-18), sodium lauryl/cetearyl sulfate, sodium lauryl/oleyl sulfate, sodium trideceth-3 carboxylates, sodium trideceth sulfate, the corresponding salts and combinations thereof.

Commercially available anionic surfactants include POLYSTEP™ A16 (sodium dodecyl benzyl sulphonate from Stepan Company, HOSTAPUR™ SAS 30 (secondary alkyl sulphonate sodium salt), EMULSOGEN™ LS (sodium laury sulphate), EMULSOGEN™ EPA 1954 (mixture of C₁₂ to C₁₄ sodium alkyl sulfates) available from Clariant, GmbH, Germany, TRITON™ X-200 (sodium alkylsulfonate) available from Union Carbide and Edenor™ C12 (Lauric Acid).

Typical amphoteric surfactants include N-alkyl betaines, which may be derivatives of trimethyl glycine or, for example, N-alkyl amino propionates. Examples of commercially available amphoteric surfactants include: acetylated lecithin, aminopropyl laurylglutamine, C₁₂₋₁₄ alkyl dimethyl betaine, capric/caprylic amidopropyl betaine, capryloamidopropyl betaine, cetyl betaine, cocamidopropyl dimethylaminohydroxypropyl hydrolyzed collagen, N,N-dimethyl-N-lauric acid-amidopropyl-N-(3-sulfopropyl)-ammonium betaine, N,N-dimethyl-N-myristyl-N-(3-sulfopropyl)-ammonium betaine, N,N-Dimethyl-N-palmityl-N-(3-sulfopropyl)-ammonium betaine, N,N-Dimethyl-N-stearamidopropyl-N-(3-sulfopropyl)-ammonium betaine, N,N-dimethyl-N-stearyl-N-(3-sulfopropyl)-ammonium betaine, ethylhexyl dipropionate, isostearamidopropyl betaine, octyl dipropionate, C₁₂₋₁₅ alkoxypropyl iminodipropionates, stearyl betaine.

Preferred ionic surfactants according to the invention are non-fluorinated surfactants. Also preferred ionic surfactants are non-aromatic surfactants. More preferred are non-fluorinated, non-aromatic, ionic surfactants.

Typical cations (counterions) corresponding to the anionic groups of the ionic surfactants may be selected from the group consisting of H⁺, alkaline metal cations, such as for example Na⁺, K⁺ or Li⁺, ammonium or substituted ammonium, such as for example alkyl ammonium, dialkyl ammonium, trialkylammonium and tetraalkylammonium, group II metal cations, such as magnesium or calcium cations or lanthanoid cations.

### The Fluoropolymer Dispersion

The fluoropolymer dispersions from which the fluorinated emulsifier is to be removed or in which the amount thereof is to be reduced can originate from any source but are typically aqueous fluoropolymer dispersions resulting from an aqueous emulsion polymerization of fluoromonomers. Typically a raw dispersion, that is, the dispersion directly obtained after emulsion polymerization, commonly comprises between about 5% and about 35% by weight of fluoropolymer. Concentrated dispersions, that is, dispersions having a fluoropolymer content of between about 35% and about 70% by weight, are usually obtained in a separate concentration step by concentrating the crude reaction mixture for example, by ultrafiltration, evaporation, thermal decantation or electrodecantation.

The fluoropolymer contained in the dispersion includes melt-processible as well as non-melt processible fluoropolymers.

Melt-processible fluoropolymers include the so-called fluorothermoplasts and fluoropolymers for the preparation of fluoroelastomers.

Fluorothermoplasts typically have a pronounced melting point.

Examples of non-melt processible fluoropolymers include polytetrafluoroethylene (PTFE) and so-called modified PTFE, which is a polymer of tetrafluoroethylene modified with minor amounts, for example, 1% or less, of another fluorinated monomer such as for example a perfluorinated vinyl ether.

The fluoropolymer of the fluoropolymer dispersion may also be a polymer that upon curing results a fluoroelastomer. Typically, such fluoropolymers are amorphous fluoropolymers that have no melting point or that have a hardly noticeable melting point. Still further, the fluoropolymer may comprise so-called micro-powder, which is typically a low molecular weight polytetrafluoroethylene. Due to the low molecular weight of the PTFE, micro-powders are melt processible.

Examples of fluoropolymers of the fluoropolymer dispersion include polymers based on tetrafluorethylene (TFE), such as TFE homopolymers (PTFE) or TFE copolymers. TFE copolymers may be copolymers with monomers containing at least one unsaturated carbon-carbon functionality. For example, the polymer may comprise repeating units derived from vinylidene fluoride. The polymer may also comprise repeating units derived from hexafluoropropylene. The polymer may also comprise repeating units derived from vinylidene fluoride and hexafluoropropylene. The polymer may also comprise repeating units derived from vinylidene fluoride, hexafluoropropylene and tetrafluoroethylene. Other examples of fluoropolymers of the fluoropolymer dispersion are VDF (vinylidene fluoride)-based homopolymers or copolymers, VDF-based fluoroelastomes, CTFE (chlortrifluoroethylene)-based homopolymers or copolymers. Further examples are modified PTFE, micro-powder, a copolymer of vinylidene fluoride and hexafluoropropylene, a copolymer of tetrafluoroethylene and vinylidene fluoride, a copolymer of tetrafluoroethylene and propylene, a copolymer of tetrafluoroethylene and perfluorovinyl ether, a copolymer of tetrafluorethylene and hexafluoropropylene, a copolymer of vinylidene fluoride and perfluorovinyl ether, a copolymer of tetrafluoroethylene, ethylene or propylene and perfluorovinyl ether, a copolymer of tetrafluoroethylene, hexafluoropropylene and perfluorovinylether, a copolymer of tetrafluoroethylene, vinylidene fluoride and hexafluoropropylene and optionally chlorotrifluoroethylene (CTFE), a copolymer of vinylidene fluoride, tetrafluoroethylene and perfluorovinyl ether and a copolymer of tetrafluoroethylene, ethylene or propylene, hexafluoropropylene and perfluorovinyl ether, or terpolymers of tetrafluoroethylene, hexafluoropropylene and vinylidene fluoride.

A preferred fluoropolymer according to the invention is a polymer having a melting point below about 200° C. Another preferred fluoropoylmer of the invention is a poylmer having a melting point between about 100° C. and about 170° C., more preferably between 120° C. and 160° C.

The particle size of the fluoropolymer in the aqueous fluoropolymer dispersion is typically between 50 nm and 400 nm (number average diameter). Smaller particle sizes are contemplated as well, for example between 20 nm and 50 nm, which may be typically obtained with microemulsion polymerization.

The dispersion may be monomodal, bimodal or multimodal, preferably monomodal or bimodal with respect to particle sizes.

The use of non-ionic surfactants is not mandatory. Therefore, the fluoropoymer dispersion may contain no non-ionic surfactants, or only small amounts thereof. Small amounts of non-ionic surfactants in the meaning of the invention are less than 0.5%, preferably less than 0.1%, more preferably less than 0.05% and most preferably less than 0.025% by weight based on the solid content of the dispersion.

Although not mandatory, the fluoropolymer dispersion may contain non-ionic surfactants including, for example, those described in WO00/35971 and in particular those that correspond to the formula:

R₁—O—[CH₂CH₂O]ₙ—[R₂O]ₘ—R₃,

wherein
R₁ represents an aromatic or aliphatic hydrocarbon or a primary or secondary alcohol group having at least 8 carbon atoms, R₂ represents an alkylene having 3 carbon atoms, R₃ represents hydrogen or a C₁-C₃ alkyl group, n has a value of 0 to 40, m has a value of 0 to 40 and the sum of n+m being at least 2.

It will be understood that in the above formula, the units indexed by n and m may appear as blocks or they may be present in an alternating or random configuration.

Examples of surfactants according to the above formula include ethoxylated p-isooctylphenol commercially available under the brand name TRITON™ such as for example TRITON™ X 100 wherein the number of ethoxy units is about 10.

Still further examples include those in which R₁ in the above formula represents an alkyl group of 4 to 20 carbon atoms, m is 0 and R₃ is hydrogen. An example thereof includes isotridecanol ethoxylated with about 8 ethoxy groups, commercially available as GENAPOL® X 080 from Clariant GmbH. Non-ionic surfactants according to the above formula in which the hydrophilic part comprises a block-copolymer of ethoxy groups and propoxy groups may be used and well. Such non-ionic surfactants are commercially available from Clariant GmbH under the trade designation GENAPOL® PF 40 and GENAPOL® PF 80, or TERGITOL™ TMN 10×, TERGITOL™ TMN 10 and TERGITOL™ TMN 6 available from Dow Chemical.

Other nonionic surfactants, which can be optionally used, are amine oxide surfactants, such as alkyamine oxides, that is, surfactants containing alkyl groups and amine oxide (N⁺—O⁻) groups like, for example, dimethyl alkyl amine oxides (EMPIGEN™ OS series from Huntsman Peformance Products, Woodlands, Tex., USA) or amido propylamine oxides, (OXAMIN™ from Huntsman Performance Products). Amine oxides surfactants may be present in amounts up to 5% based on the solid content of the dispersion.

### Process of Removing the Fluorinated Emulsifier

The fluorinated emulsifier is removed from the fluoropolymer dispersion containing it by contacting the dispersion with a basic anion exchange resin in the presence of non-fluorinated ionic surfactant.

In the process according to the invention the dispersion may be treated with the ionic surfactant before or while the dispersion is contacted with the anion exchange resin. This can be carried out by adding ionic surfactant to the dispersion. A preferred way involves contacting the dispersion with the ionic surfactant by using an anion exchange resin that has been loaded with the ionic surfactants prior to the resin being contacted with the dispersion. The resin is believed to release the ionic surfactants while binding the fluorinated emulsifiers, which is believed to lead to a stabilization of the dispersion.

It is also within the meaning of the invention that the dispersion may be treated with ionic surfactants additionally to the use of the ion exchange resin loaded with ionic surfactants.

It is also possible to employ combinations of ionic surfactants, for example employing a resin loaded with an anionic surfactant and adding the same or a different anionic surfactant to the dispersion before, during or after it is contacted with the resin.

The ionic surfactant is used in an amount that is effective in stabilising the dispersion. The ionic surfactant may be chosen such that the amount of ionic surfactant after the anion exchange is at least about 0.02%, or at least about 0.5%, preferably at least about 1.0% by weight based on the solid content of the dispersion. The upper range of the amount of anionic surfactant in the dispersion is chosen such that the viscosity of the dispersion still allows coating of substrates. Typically, the ionic surfactant may by be present in the dispersion in an amount of up to about 10%, preferably up to about 8% or more preferably up to about 6% by weight based on the solid content of the dispersion.

To the fluoropolymer dispersion may further be added compounds to destroy residual initiators such as residual persulfate to suppress corrosion of the process equipment. For example, organic reducing agents such as hydroxylamines, azodicarbonamides and vitamin C may be added.

The dispersion, from which the fluorinated polymer is to be removed, may have a pH from 2 to 11, preferably a pH from about 3 to about 10. Prior to submitting the dispersion to the treatment with the ionic surfactants the pH of the dispersion may have to be adapted to the nature (pKa) of the ionic surfactant to be used. For example, the pH of the dispersion may be adjusted to ensure the ionic surfactant is predominantly in its anionic form. Likewise, an ionic surfactant may be selected that is compatible with the pH of the dispersion and pH adjustement of the dispersion may not be necessary.

The fluorinated emulsifier may be present in any amount in the fluoropolymer dispersion from which it is to be removed in amounts between about 0.02% and about 5% by weight based on the solid content in the dispersion, more typically between about 0.05% and about 2%.

The fluoropolymer dispersion from which the emulsifier may be removed may be the raw dispersion or the concentrated dispersion, with the raw dispersion being preferred. After reducing the amount of fluorinated emulsifier in the raw dispersion, the dispersion may be concentrated.

Accordingly, there is also provided a fluoropolymer raw dispersion and a concentrated dispersion comprising
a) from about 5% to about 35% (in case of the raw dispersion) or from about 35% to about 70% by weight of fluoropolymer (in case of the concentrated dispersion),
b) less than about 0.02%, preferably less than about 0.01%, more preferably less than about 0.005% by weight based on the solid content of the dispersion of fluorinated emulsifier,
c) at least about 0.02%, preferably at least about 0.5%, more preferably at least 1.0% or from about 0.02% to about 10%, or from about 0.5% to about 8% or from about 1.0 to about 6% by weight based on the solid content of the dispersion of the non-fluorinated ionic surfactant, and
d) less than about 0.5%, preferably less than about 0.1%, more preferably less than about 0.05% and most preferably less than about 0.01% or from about 0.001 to about 0.05% by weight based on the solid content of non-ionic surfactants.

After removal of fluorinated emulsifier according to the invention the fluoropolymer dispersions may be useful in coating or impregnating of substrates at moderate temperatures, that is, at temperatures up to about 260° C., preferably up to about 200° C. The fluoropolymer dispersion may also be used in coating or impregnating compositions that degrade at temperature below 260° C., or below 200° C.

In particular, the fluoropolymer dispersion obtained by the process according to the invention may be suitable for the impregnation of fibres, such as for example textiles, paper, glass fabrics or fabrics containing organic polymers, such as for examples polyester, polypropylene, polyethylene, or poylacetates.

The fluoropolymer dispersions may also be used in coating of substrates involving coagulation of the dispersion. The fluoropolymer dispersions may also be used in coating of substrates for creating hard and resistant surfaces. Therefore, another application for the fluoropolymer dispersions obtained by the process according to the invention is coating of metal surfaces or coating of bearings such as for example, sliding-contact bearings, bush bearings, friction-type contact bearings etc.

### Fluorinated Emulsifier

The fluorinated emulsifier is typically an anionic fluorinated surfactant as commonly used in the aqueous emulsion polymerization used of fluoropolymers. Commonly used fluorinated surfactants are non-telogenic and include those that correspond to the formula (I):

(Y—R_{f}—Z)n-M, (I)

wherein Y represents hydrogen, Cl or F; R_{f} represents a linear or branched perfluorinated alkylene having 4 to 10 carbon atoms; Z represents COO⁻ or SO₃⁻; M represents a cation including monovalent and multivalent cations, for example, an alkali metal ion, an ammonium ion or a calcium ion and n corresponds to the valence of M and typically has a value of 1, 2 or 3.

Representative examples of fluorinated emulsifiers according to above formula (I) are perfluoroalkanoic acids and salts thereof such as perfluorooctanoic acid and its salts in particular ammonium salts.

Other fluorinated emulsifiers used according to the invention include those fluorinated carboxylic acids or salts thereof that correspond to the general formula (II):

[R_{f}—O-L-COO⁻]ᵢXⁱ⁺ (II)

wherein L represents a linear partially or fully fluorinated alkylene group or an aliphatic hydrocarbon group, R_{f} represents a linear partially or fully fluorinated aliphatic group or a linear partially or fully fluorinated aliphatic group interrupted with one or more oxygen atoms, Xⁱ⁺ represents a cation having the valence i and i is 1, 2 or 3. Examples of cations include H⁺, ammonium, monovalent metal cations, divalent metal cations and trivalent cations. Typical cations are H⁺ and NH₄⁺.

For the sake of convenience, the term ‘fluorinated carboxylic acid’ is hereinafter used to indicate the free acid as well as salts thereof. Generally, the fluorinated carboxylic acid will be a low molecular weight compound, for example a compound having a molecular weight for the anion part of the compound of not more than 1000 g/mol, typically not more than 600 g/mol and in particular embodiments, the anion of the fluorinated carboxylic acid may have a molecular weight of not more than 500 g/mol.

Preferred compounds are those in which any fluorinated alkylene groups have not more than 3 carbon atoms and in which a fluorinated alkyl group of the compound has not more than 3 carbon atoms.

In the above formula (II), L represents a linking group. In one embodiment, the linking group can be a linear partially or fully fluorinated alkylene. Fully fluorinated alkylene groups include alkylene groups that consist of only carbon and fluorine atoms whereas partially fluorinated alkylene groups may additionally contain hydrogen. Generally, a partially fluorinated alkylene group should not contain more than 2 hydrogen atoms so as to be highly fluorinated and be non-telogenic or at least have minimal telogenic effects.

Examples of fully fluorinated alkylene groups include linear perfluorinated alkylenes that have from 1 to 6 carbon atoms, for example linear perfluorinated alkylene groups of 1, 2, 3, 4 or 5 carbon atoms.

Examples of linear partially fluorinated alkylene groups include those that have from 1 to 6 carbon atoms. In a particular embodiment the linear partially fluorinated alkylene linking group has 1, 2, 3, 4, 5 or 6 carbon atoms and has only 1 or 2 hydrogen atoms. When the partially fluorinated alkylene group has 2 hydrogen atoms, they may be attached to the same carbon atom or they can be attached to different carbon atoms. When they are attached to different carbon atoms, such carbon atoms can be adjacent to each other or not. Also, in a particular embodiment, a carbon atom having 1 or 2 hydrogen atoms may be adjacent the ether oxygen atom to which the linking group is attached or adjacent the carboxylic group to which the linking group is attached at its other end.

In a further embodiment, the linking group L is an aliphatic hydrocarbon group. Examples of aliphatic hydrocarbon groups include linear, branched or cyclic aliphatic groups. Particular examples of aliphatic groups include linear or branched alkylene groups of 1 to 4 carbon atoms such as for example methylene or ethylene.

Particular examples of linking groups L may be selected from the following:
(CF₂)_{g}— wherein g is 1, 2, 3, 4, 5 or 6;
CFH—(CF₂)ₕ— wherein h is 0, 1, 2, 3, 4 or 5;
CF₂—CFH—(CF₂)_{d}— wherein d is 0, 1, 2, 3 or 4;
CH₂—(CF₂)ₕ— wherein h is 1, 2, 3 or 4;
(CH₂)_{c}— wherein c is 1, 2, 3 or 4;

In the above examples, the left side of the formula of the linking group is the site where the linking group is connected to the ether oxygen in formula (II).

The R_{f} group in formula (II) represents a linear partially or fully fluorinated aliphatic group or a linear partially or fully fluorinated aliphatic group interrupted with one or more oxygen atoms. In one embodiment, R_{f} is a linear perfluorinated aliphatic group having 1 to 6 carbon atoms, preferably having 1, 2, 3 or 4 carbon atoms. According to another embodiment R_{f} is a linear perfluorinated aliphatic group interrupted with one or more oxygen atoms of which the alkylene groups between oxygen atoms have not more than 4 or 6 carbon atoms, for example 3 or less carbon atoms and wherein the terminal alkyl group has not more than 4 or 6 carbon atoms, for example 3 or less carbon atoms. According to a still further embodiment, R_{f} is a linear partially fluorinated aliphatic group having 1 to 6 carbon atoms and not more than 2 hydrogen atoms or a linear partially fluorinated aliphatic group interrupted with one or more oxygen atoms and which has not more than 2 hydrogen atoms. In the latter embodiment, it will generally be preferred that any perfluorinated alkylene moiety has not more than 4 or 6 carbon atoms and any terminal perfluorinated alkyl group, likewise preferably should not have more than 6 carbon atoms, for example not more than 4 carbon atoms. A particular example of a partially fluorinated aliphatic group R_{f} is CF₃CFH—.

In a particular embodiment, R_{f} may correspond to the following formula:

R_{f}¹—[OR_{f}²]ₚ—[OR_{f}³]_{q}— (III)

wherein R_{f}¹ is a perfluorinated linear aliphatic group of 1 to 6 carbon atoms (for example 3 or less), R_{f}² and R_{f}³ each independently represents a linear perfluorinated alkylene of 1, 2, 3 or 4 carbon atoms and p and q each independently represent a value of 0 to 4 and wherein the sum of p and q is at least 1.

In another embodiment, R_{f} may correspond to the following formula:

R⁷_{f}—(O)ₜ—CFH—CF₂— (IV)

wherein t is 0 or 1 and R₇^{f} represents a linear partially or fully fluorinated aliphatic group optionally interrupted with one or more oxygen atoms. Typically R₇^{f} does not contain perfluorinated aliphatic moieties of more than 4 or 6 carbon atoms. For example, in one embodiment, R⁷_{f} is a perfluorinated linear aliphatic group of 1 to 6 carbon atoms. In another embodiment, R⁷_{f} is a group corresponding to above formula (III).

In yet a further embodiment, R_{f} may correspond to the following formula:

R_{f}⁸—(OCF₂)ₐ— (V)

wherein a is an integer of 1 to 6 and R_{f}⁸ is a linear partially fluorinated aliphatic group or a linear fully fluorinated aliphatic group having 1, 2, 3 or 4 carbon atoms. When R_{f}⁸ is a partially fluorinated aliphatic group, the number of carbon atoms preferably is between 1 and 6 and the number of hydrogen atoms in the partially fluorinated aliphatic groups is preferably 1 or 2.

In a still further embodiment, R_{f} may correspond to the following formula:

R_{f}⁹—O—(CF₂)_{b}— (VI)

wherein b is an integer of 1 to 6, preferably 1, 2, 3 or 4 and R_{f}⁹ is a linear partially fluorinated aliphatic group or a linear fully fluorinated aliphatic group having 1, 2, 3 or 4 carbon atoms. When R_{f}⁹ is a partially fluorinated aliphatic group, the number of carbon atoms preferably is between 1 and 6 and the number of hydrogen atoms in the partially fluorinated groups is preferably 1 or 2.

In a particular embodiment of the present invention, the fluorinated carboxylic acid corresponds to the following formula:

[R_{f}^{a}—(O)ₜ—CHF—(CF₂)ₙ—COo⁻]ᵢXⁱ⁺ (VII)

wherein R_{f}^{a} represents a linear partially or fully fluorinated aliphatic group optionally interrupted with one or more oxygen atoms, t is 0 or 1 and n is 0 or 1, Xⁱ⁺ represents a cation having a valence i and i is 1, 2 or 3, with the proviso that when t is 0, the R_{f}^{a} contains at least one ether oxygen atom.

In a particular aspect of this embodiment, the R_{f}^{a} is selected from the group consisting of linear perfluorinated aliphatic groups of 1 to 6 carbon atoms, preferably having 1 to 4 carbon atoms, perfluorinated groups of the formula R_{f}¹—[OR_{f}²]ₚ-[OR_{f}³]_{q}— wherein R_{f}¹ is a linear perfluorinated aliphatic group of 1 to 6 carbon atoms, preferably 1 to 4 carbon atoms, R_{f}² and R_{f}³ each independently represents a linear perfluorinated alkylene of 1, 2, 3 or 4 carbon atoms and p and q each independently represent a value of 0 to 4 and wherein the sum of p and q is at least 1 and perfluorinated groups of the formula R_{f}⁴—[OR_{f}⁵]ₖ—[OR_{f}⁶]ₘ—O—CF₂— wherein R_{f}⁴ is a linear perfluorinated aliphatic group of 1 to 6 carbon atoms, preferably 1 to 4 carbon atoms, R_{f}⁵ and R_{f}⁶ each independently represents a linear perfluorinated alkylene of 1, 2, 3 or 4 carbon atoms and k and m each independently represent a value of 0 to 4.

Fluorinated carboxylic acid of formula (VII) can be derived from fluorinated olefins of the general formula:

R^{a}_{f}—(O)ₜ—CF═CF₂ (VIa)

wherein R^{a}_{f} and t are as defined above. Compounds according to formula (VIIa) are well known in the art and include fluorinated olefins such as perfluorinated alkyl vinyl compounds, vinyl ethers in particular perfluorovinyl ethers and allyl ethers, in particular perfluorinated allyl ethers.

Fluorinated carboxylic acids according to formula (VII) wherein n is 0 can be prepared by reacting a fluorinated olefin of formula (VIa) with a base. The reaction is generally carried out in aqueous media. An organic solvent may be added to improve the solubility of the fluorinated olefin. Examples of organic solvents include glyme, tetrahydrofuran (THF) and acetonitrile. Additionally or alternatively a phase transfer catalyst may be used. As a base, use can be made of for example ammonia, alkali and earth alkali hydroxides. Without intending to be bound by any theory, it is believed, that the reaction proceeds according to the following sequence when ammonia is used as a base:

R_{f}—(O)ₜ—CF═CF₂+NH₃+H₂O→R_{f}—(O)ₜ—CHF—COONH₄+NH₄F

The reaction is generally carried out between 0 and 200° C., for example between 20-150° C. and at a pressure between about 1 bar up to about 20 bar. For further purification, the obtained salts can be distilled via the free acid or by first converting the acid into an ester derivative and then distilling the ester derivative followed by hydrolysis of the ester to obtain the purified acid or salt thereof.

Fluorinated carboxylic acids of formula (VII) wherein n is 0 can also be prepared by reacting a fluorinated olefin of formula (VIIa) with a hydrocarbon alcohol in an alkaline medium and then decomposing the resulting ether in acidic conditions thereby forming the corresponding carboxylic acid. Suitable hydrocarbon alcohols include aliphatic alcohols such as lower alkanols having 1 to 4 carbon atoms. Specific examples include methanol, ethanol and butanol including t-butanol. The reaction of the fluorinated olefin with the alcohol in an alkaline medium may be carried out as described in “Furin et al., Bull Korean Chem. Soc. 20, 220 [1999]”. The reaction product of this reaction is an ether derivative of the fluorinated olefin. This resulting ether can be decomposed under acidic conditions as described in “D. C. England, J. Org. Chem. 49, 4007 (1984)” to yield the corresponding carboxylic acid or salt thereof.

To prepare fluorinated carboxylic acids of formula (VII) wherein n is 1, a free radical reaction of the fluorinated olefin of formula (VIa) with methanol may be carried out followed by an oxidation of the resulting reaction product. The free radical reaction is typically carried out using a free radical initiator as is typically used in a free radical polymerization reaction. Examples of suitable free radical initiators include persulfates such as for example ammonium persulfate. Detailed conditions of the free radical reaction of the fluorinated carboxylic acid with an alcohol can be found in “S. V. Sokolov et al., Zh. Vses. Khim Obsh 24, 656 (1979)”. The resulting alcohol derivative of the fluorinated olefin can be chemically oxidized with an oxidizing agent to the corresponding carboxylic acid. Examples of oxidizing agents include for example potassium permanganate, chromium (VII) oxide, RuO₄ or OSO₄ optionally in the presence of NaOCl, nitric acid/iron catalyst, dinitrogen tetroxide. Typically the oxidation is carried out in acidic or basic conditions at a temperature between 10 and 100° C. In addition to chemical oxidation, electrochemical oxidation may be used as well.

In another embodiment, the fluorinated carboxylic acid corresponds to the following formula:

R_{f}^{b}—(O)ₜ—CFH—CF₂—O—R-G (VIII)

wherein R_{f}^{b} represents a linear partially or fully fluorinated aliphatic group optionally interrupted with one or more oxygen atoms, R is an aliphatic hydrocarbon group, G represents a carboxylic acid or salt thereof, t is 0 or 1. Particular examples for R include a methylene group or an ethylene group.

In a particular aspect of this embodiment, the R_{f}^{b} is selected from the group consisting of linear perfluorinated aliphatic groups of 1 to 6 carbon atoms, preferably having 1 to 4 carbon atoms, perfluorinated groups of the formula R_{f}¹—[OR_{f}²]ₚ-[OR_{f}³]_{q}— wherein R_{f}¹ is a linear perfluorinated aliphatic group of 1 to 6 carbon atoms, preferably 1 to 4 carbon atoms, R_{f}² and R_{f}³ each independently represents a linear perfluorinated alkylene of 1, 2, 3 or 4 carbon atoms and p and q each independently represent a value of 0 to 4 and wherein the sum of p and q is at least 1 and perfluorinated groups of the formula R_{f}⁴—[OR_{f}⁵]ₖ-[OR_{f}⁶]ₘ—O—CF₂— wherein R_{f}⁴ is a linear perfluorinated aliphatic group of 1 to 6 carbon atoms, preferably 1 to 4 carbon atoms, R_{f}⁵ and R_{f}⁶ each independently represents a linear perfluorinated alkylene of 1, 2, 3 or 4 carbon atoms and k and m each independently represent a value of 0 to 4.

Fluorinated carboxylic acids according to formula (VIII) may be prepared through the preparation of an intermediate of formula (VIIIa):

R_{f}^{b}—(O)ₜ—CFH—CF₂—O—R-Z

wherein R_{f}^{b}, t and R have the same meaning as defined above. Z represents a carboxylic acid ester or a carboxylamide.

The intermediate compound according to formula (VIIIa) can be prepared by reacting a fluorinated olefin of the general formula (VIa) with an organic compound of the formula

HO—R—Z (VIIIb)

wherein Z and R are as defined above. Compounds according to formula (VIIIb) are well known in the art and/or are commercially available. The reaction of compound (VIIa) with compound (VIIIb) is typically carried out in the presence of a base although it is also possible to carry out the reaction under acidic or neutral conditions. Suitable bases include carbonates such as potassium carbonate, sodium carbonate and lithium carbonate, hydroxides, alkoholates etc. The amount of base used may vary widely. For example a catalytic amount may be used. Generally the amount of base used will be about at least 1 or 2% by weight based on the amount of reactant of formula (VIIIb). In a particular embodiment, the amount of base can be upto 2 times the molar amount of the reactant of formula (VIIIb). The reaction is typically carried out in an aprotic solvent such as for example, tetrahydrofuran, acetonitrile, glyme, diglyme etc. Further suitable aprotic solvents are disclosed in DE 3828063. The reaction is typically carried out a temperature between 0 and 200° C., for example between 10 and 150° C. The reaction is generally carried out at an ambient pressure (1 bar) or up to 20 bar. Following the reaction, the resulting compound may be isolated and purified by distillation.

The fluorinated carboxylic acids of formula (VIII) can be readily prepared by hydrolyzing the intermediate compound of formula (VIIIa) above. In formula (VIIIa) above, Z represents a carboxylic acid ester or a carboxylamide. Typically a carboxylic acid ester is used. In one embodiment, the ester can be an aliphatic ester, for example, an alkyl ester in which the number of carbon atoms in the alkyl group are from 1 to 4. Hydrolysis of the intermediate compound may be carried out under acidic or basic conditions and is generally carried out in an alcoholic acidic or basic solution of the intermediate compound. Alternatively the intermediate compound may be hydrolysed in an acidic or basic solution of other water miscible organic solvents such as ketones, ethers etc. Typically, a basic alcoholic solution is used such as for example a methanol or ethanol solution containing an alkali metal hydroxide as the base. Typically the hydrolysis is carried out at room temperature but it is also possible to use elevated temperatures of for example up to the boiling point of the solution.

Alternatively, the fluorinated surfactant may be prepared by reacting the fluorinated olefin of formula (VIIa) above with a hydroxy substituted carboxylic acid or salt thereof. Thus, in accordance with this embodiment the fluorinated olefin of formula (VIIa) is reacted with a compound of the formula:

HO—R-G (VIIIc)

wherein G is a carboxylic acid group or salt thereof and R is as defined above. The reaction of a fluorinated olefin of formula (VIIa) with a hydroxy compound or formula (VIIIc) can be carried out under the same conditions described above for the reaction with compounds of formula (VIIIb).

In a still further embodiment, the fluorinated carboxylic acid corresponds to one of the following formulas:

R_{f}^{c}—(OCF₂)ᵤ—O—(CF₂)ᵥ-AC (IX)

wherein u is an integer of 1 to 6, v is an integer of 1 to 6, R_{f}^{c} represents a linear perfluorinated aliphatic group of 1, 2, 3 or 4 carbon atoms and AC represents a carboxylic acid group or salt thereof, and

R_{f}^{c}—O—(CF₂)_{y}—O-L¹-AC (X)

wherein y has a value of 1, 2, 3, 4, 5 or 6, L¹ represents a linear perfluorinated alkylene of 1, 2, 3, 4, 5 or 6 carbon atoms or a linear partially fluorinated alkylene having 1 to 6 carbon atoms and 1 or 2 hydrogen atoms, R_{f}^{c} is as defined in above formula (IX) and AC represents a carboxylic acid group or salt thereof. A particular example for L¹ includes a group of the formula —CFH—. Particular compounds according to formula (X) include those wherein R_{f}^{c} represents CF₃CFH—. Such groups can be obtained from decarboxylation of —CF(CF₃)COOX groups (X is a cation) in the presence of a protic substance as described in JOC 34, 1841 (1969).

Fluorinated carboxylic acids of formula (IX) are commercially available from Anles Ltd., St. Petersburg, Russia. These compounds may be prepared for example as described by Ershov and Popova in Fluorine Notes 4(11), 2002. Also, these fluorinated carboxylic acids typically form as byproducts in the manufacturing of hexafluoropropylene oxide by direct oxidation of hexafluoropropylene.

Fluorinated carboxylic acids according to formula (X) can be derived from reactants that are also used in the manufacturing of fluorinated vinyl ethers as described in U.S. Pat. No. 6,255,536.

In another embodiment acid fluorides of formula (XI) are reacted with a metal fluoride like KF or CsF:

R_{f}^{g}—COF (XI)

wherein R_{f}^{g} is a partially or perfluorinated linear aliphatic chain optionally interrupted with one or more oxygen atoms. This reaction results in an alkoxylate that can be further reacted with a carboxylic acid derivative of formula (XII)

Y—(CH₂)ₙ-Q (XII)

wherein Y represents a leaving group like iodide, bromide, chloride, mesylate, tosylate and the like, n is an integer from 1 to 3, and Q represents a carboxyl acid group or a lower alkyl ester. The reaction results in fluorinated carboxylic acid derivatives of formula (XIII)

R_{f}^{g}—CF₂—O—(CH₂)ₙQ (XIII)

with R_{f}^{g}n, and Q having the same meaning as above. The corresponding salts can be obtained by saponification.

In yet a further embodiment the fluorinated carboxylic acids correspond to formula (XIV)

CF₃—CF₂—O—R_{f}^{h}—COOX (XIV)

with R_{f}^{h} representing a linear partially or fully fluorinated linear carbon chain of 1 to 8 carbon atoms optionally interrupted with one or more oxygen atoms, for example a perfluorinated linear aliphatic group of 1 to 6 carbon atoms, for example 1, 2, 3 or 4 carbon atoms and X is a monovalent cation. Compounds of this formula can be made by conversion of diacid difluorides of formula (XV) in the presence of for example, antimony pentafluoride.

FOC—CF(CF₃)—O—R_{f}^{h}—COF (XV)

This conversion may be carried out at elevated temperature according to the method described in U.S. Pat. No. 3,555,100 resulting preferably in the decarbonylation of the secondary COF group. The resulting mono acid fluoride can be converted to the corresponding salt using well known methods. Fluorinated carboxylic acids having a —O—CF₂—COOX group can be obtained from the corresponding vinyl ethers —O—CF═CF₂. Reaction of the vinyl ether with oxygen according to U.S. Pat. No. 4,987,254 results in acid fluorides carrying a —O—CF₂COF group which can be readily converted to the corresponding acid or salt.

Specific examples of compounds according to formula (II) include the following:

### R_{f}O—CHF—COOH:

C₃F₇—O—CHF—COOH, CF₃—O—CF₂CF₂—CF₂—O—CHF—COOH, CF₃CF₂CF₂—O—CF₂CF₂—CF₂—O—CHF—COOH, CF₃—O—CF₂—CF₂—O—CHF—COOH, CF₃—O—CF₂—O—CF₂—CF₂—O—CHF—COOH, CF₃—(O—CF₂)₂—O—CF₂—CF₂—O—CHF—COOH,

### CF₃—(O—CF₂)₃—O—CF₂—CF₂—O—CHF—COOH;

### R_{f}O—CHF—CF₂—COO H:

CF₃—O—CHF—CF₂—COOH, CF₃—O—CF₂—CF₂—O—CHF—CF₂—COOH, CF₃—CF₂—O—CHF—CF₂—COOH, CF₃—O—CF₂—CF₂—CF₂—O—CHF—CF₂—COOH, CF₃—O—CF₂—O—CF₂—CF₂—O—CHF—CF₂—COOH, CF₃—(O—CF₂)₂—O—CF₂—CF₂—O—CHF—CF₂—COOH, CF₃—(O—CF₂)₃—O—CF₂—CF₂—O—CHF—CF₂—COOH;

### R_{f}O—CF₂—CHFCOOH:

CF₃—O—CF₂—CHF—COOH, C₃F₇—O—CF₂—CHF—COOH, CF₃—O—CF₂—CF₂—CF₂—O—CF₂—CHF—COOH, CF₃—O—CF₂—O—CF₂—CF₂—O—CF₂—CHF—COOH, CF₃—(O—CF₂)₂—O—CF₂—CF₂—O—CF₂—CHF—COOH, CF₃—(O—CF₂)₃—O—CF₂—CF₂—O—CF₂—CHF—COOH;

### R_{f}O—CF₂—CHF—CF₂COO H:

CF₃—O—CF₂—CHF—CF₂—COOH, C₂F₅—O—CF₂—CHF—CF₂—COOH, C₃F₇—O—CF₂—CHF—CF₂—COOH, CF₃—O—CF₂—CF₂—CF₂—O—CF₂—CHF—CF₂—COOH, CF₃—O—CF₂—O—CF₂—CF₂—O—CF₂—CHF—CF₂—COOH, CF₃—(O—CF₂)₂—O—CF₂—CF₂—O—CF₂—CHF—CF₂—COOH, CF₃—(O—CF₂)₃—O—CF₂—CF₂—O—CF₂—CHF—CF₂—COOH;
R_{f}(O)ₘ—CHF—CF₂—O—(CH₂)ₙ—COOH n=1, 2 or 3; m=0 or 1:
CF₃—O—CHF—CF₂—O—CH₂—COOH, CF₃—O—CF₂—CF₂—CF₂—O—CHF—CF₂—O—CH₂—COOH, C₃F₇—O—CHF—CF₂—O—CH₂—COOH, C₃F₇—O—CHF—CF₂—O—CH₂—CH₂—COOH, C₃F₇—O—CF₂—CF₂—O—CHF—CF₂—OCH₂COOH, C₃F₇—O—CF₂—CF₂—CF₂—O—CHF—CF₂—OCH₂COOH, C₃F₇—O—CF₂—CHF—CF₂—OCH₂COOH, CF₃—CHF—CF₂—O—CH₂COOH, C₃F₇—CF₂—CHF—CF₂—OCH₂—COOH, CF₃—O—CF₂—CF₂—O—CH₂—COOH, CF₃—O—CF₂—CF₂—CF₂—O—CF₂—CF₂—O—CH₂—COOH, C₃F₇—O—CF₂—CF₂—O—CH₂—COOH, C₃F₇—O—CF₂—CF₂—O—CH₂—CH₂—COOH, C₃F₇—O—CF₂—CF₂—O—CF₂—CF₂—OCH₂COOH, C₃F₇—O—CF₂—CF₂—CF₂—O—CF₂—CF₂—OCH₂COOH, C₃F₇—O—CF₂—CF₂—CF₂—OCH₂COOH, C₄F₉—O—CH₂—COOH, C₄F₉—O—CH₂—CH₂—COOH, C₃F₇—O—CH₂COOH, C₆F₁₃—OCH₂—COOH, R_{f}—O—CF₂—CF₂—COOH, CF₃—O—CF₂—CF₂—COOH, C₂F₅—O—CF₂—CF₂—COOH, C₃F₇—O—CF₂—CF₂—COOH,

### C₄F₉—O—CF₂—CF₂—COOH,

R_{f}—(O—CF₂)ᵤ—O—CF₂—COOH with u being as defined above:
CF₃—(O—CF₂)₃—O—CF₂—COOH, CF₃—(O—CF₂)₂—O—CF₂—COOH, CF₃—(O—CF₂)₁—O—CF₂—COOH;
R_{f}—(O—CF₂—CF₂)ₖ—O—CF₂—COOH with k being 1, 2 or 3:
CF₃—(O—CF₂—CF₂)₁—O—CF₂—COOH, C₂F₅—(O—CF₂—CF₂)₁—O—CF₂—COOH, C₃F₇—(O—CF₂—CF₂)₁—O—CF₂—COOH, C₄F₉—(O—CF₂—CF₂)₁—O—CF₂—COOH, C₂F₅—(O—CF₂—CF₂)₂—O—CF₂—COOH,
CF₃—(O—CF₂—CF₂)₂—O—CF₂—COOH, C₃F₇—(O—CF₂—CF₂)₂—O—CF₂—COOH, C₄F₉—(O—CF₂—CF₂)₂—O—CF₂—COOH;

### R_{f}—O—CF₂—COOH:

### C₃F₇—O—CF₂—COOH, CF₃—O—CF₂—CF₂—CF₂—O—CF₂—COOH;

CF₃—CHF—O—(CF₂)ₒ—COOH with o being an integer of 1, 2, 3, 4, 5 or 6:

### CF₃CFH—O—(CF₂)₃—COOH, CF₃CFH—O—(CF₂)₅—COOH

CF₃—CF₂—O—(CF₂)ₒ—COOH with o being as above:

### CF₃—CF₂—O—(CF₂)₃COOH, CF₃—CF₂—O—(CF₂)₅COOH

In the above generic formulas, R_{f} has the meaning as defined above in respect of generic formula (II). It is understood that while the above list of compounds only lists the acids, the corresponding salts, in particular the NH₄⁺, potassium, sodium or lithium salts can equally be used.

### The Anion Exchange

Preferably, the anion exchange resin used in the process according to the invention is basic. The anion exchange resin may be a weak, medium strong or a strong basic. The terms strong, medium strong and weak basic anion exchange resin are defined in “Encyclopedia of Polymer Science and Engineering”, John Wiley & Sons, 1985, Volume 8, page 347 and “Kirk-Othmer”, John Wiley &Sons, 3 rdedition, Volume 13, page 687. Strong basic anion exchange resin typically contain quaternary ammonium groups, medium strong resins usually have tertiary amine groups and weak basic resins usually have secondary amines as the anion exchange functions. Examples of anion exchange resins that are commercially available for use in this invention include AMBERLITE® IRA-402, AMBERJET® 4200, AMBERLITE® IRA-67 and AMBERLITE® IRA-92 all available from Rohm & Haas, PUROLITE® A845 (Purolite GmbH) and LEWATIT® MP-500 (Bayer AG), LEWATIT® MP-62 (Bayer AG), or DOWEX 550A (Dow Chemical Company) or DOWEX MARATHON A2 (Dow Chemical Company).

The resin employed in the present invention may have a Gaussian distribution of bead sizes about the average bead diameter or the beads may be monodisperse.

The anion exchange resin may be treated with anionic surfactants or mixtures thereof, which means that the resin is contacted with the anionic surfactant or mixtures thereof prior to the resin being contacted by the fluoropolymer dispersion. Contacting the anion exchange resin with the anionic surfactant to achieve loading of the resin with anionic surfactant can be carried out by using a loading medium, such as for example an aqueous surfactant solution. The surfactant is taken up by the resins by which the resin becomes loaded with the anionic surfactant. The anion exchange resin may be partially loaded, loaded to at least about 50% to at least about 70%, to at least about 80%, to at least about 90%, to at least about 95%, or it may be completely loaded. Complete loading (100% loading) is achieved if substantially no surfactant is taken up any more from the loading medium. The degree at which the resin is loaded can be adapted to the amount of fluorinated emulsifier to be removed from the dispersion and to the volume of dispersion treated. Typically, the ion-exchange resin is loaded with an amount of ionic surfactant that is effective to stabilize the fluoropolymer dispersion while being contacted with the ion exchange resin, that is, to prevent coagulation or precipitation of fluoropolymer on the resin. The effective amount can be readily determined by one skilled in the art with routine experimentation. Destabilisation of the polymer dispersion results in coagulation of polymer particles on the resin. This can be determined visibly, or for example by a pressure built-up over the resin at constant flow rate or by a reduction in flow rate through the column at constant pressure. Loading of the resin is typically done by contacting the resin with a solution containing the ionic surfactant in a sufficient concentration and for a sufficient time to achieve loading of the resin to the desired degree.

The resin may be in a “non-fixed resin bed” or in a “fixed resin bed”. In a fixed resin bed the ion-exchange resin is not agitated. Fixed resin bed typically covers column techology, in which the resin rests and removal of the substance occurs through a chromatographic process. The term non-fixed resin bed is used to indicate that the resin is agitated, for example, being fluidized, stirred or shaken. Non-fixed resin technology is described in Ullmann Encyclopedia of Industrial Chemistry, 5th Edition, Vol. A14, p 439 et seq.

The dimension of the ion exchange resin (volume of resin containing column) are adapted to the concentration of fluorinated emulsifier and volume of the fluoropolymer dispersion to be treated. In case of resins loaded with ionic surfactants, the volume of the resin and/or its loading degree is such that the amount of anionic surfactant that could be released from the resin is equal or preferably exceeds the amount of fluorinated emulsifier to be removed from the dispersion.

In accordance with the process of removal of fluorinated surfactant, the fluoropolymer dispersion is contacted with an effective amount of anion exchange resin and for a time sufficient to reduce the level of fluorinated surfactant to the desired level. It is also possible to contact the dispersion with more than one resin, for example a series of anion exchange resins according to the invention. The resins may be loaded with the same or different ionic surfactant or with the same or different mixtures thereof.

The fluoropolymer dispersion may be contacted with the anion exchange resin by mildly agitating the mixture of fluoropolymer dispersion and anion exchange resin. Ways to agitate include shaking a vessel containing the mixture, stirring the mixture in a vessel with a stirrer or rotating the vessel around its axel. The rotation around the axel may be complete or partial and may include alternating the direction of rotation. Rotation of the vessel is generally a convenient way to cause the agitation. When rotation is used, baffles may be included in the vessel. A further attractive alternative to cause agitation of the mixture of exchange resin and fluoropolymer dispersion is fluidizing the exchange resin. Fluidization may be caused by flowing the dispersion through the exchange resin in a vessel whereby the flow of the dispersion causes the exchange resin to swirl.

Contacting of the dispersion with the resin can be practiced in a so-called batch-wise manner or in a continuous manner. In a batch-wise process, a vessel is charged with the anion exchange resin and fluoropolymer dispersion. The mixture in the vessel is then agitated for a time sufficient to reduce the residual fluorinated emulsifier to the desired level after which the dispersion and exchange resin are separated, for example, through filtration. The vessel may then be charged anew with fluoropolymer dispersion and exchange resin and the process is then repeated.

In a continuous process, fluoropolymer dispersion from which fluorinated emulsifier needs to be removed is continuously added at one end to a (preferably agitating) vessel that contains anion exchange resin, and fluoropolymer dispersion having a reduced amount of fluorinated emulsifier is withdrawn at another end of the vessel in a continuous fashion. In a continuous process, the equipment will be designed such that the residence time of the dispersion in the vessel is sufficient to reduce the amount of fluorinated emulsifier to the desired level. In a particular embodiment of a continuous process, a plurality, e.g. 2 or more, (preferably agitating) vessels each charged with anion exchange resin may be used. Accordingly, fluoropolymer dispersion may be continuously added and withdrawn from the first vessel. The fluoropolymer dispersion from the first vessel may be fed continuously in the next vessel from which it is continuously withdrawn and this process can be repeated if more than 2 vessels are used. If a plurality of vessels is used, they are typically arranged in a cascading arrangement.

Anion exchange resin charged with fluorinated emulsifier can be regenerated by eluting the anion exchange resin according to the processes disclosed in for example U.S. Pat. No. 4,282,162, WO 01/32563 and EP 1 069 078 and the fluorinated emulsifer may then be recovered from the eluate. The recovered fluorinated emulsifer may thereafter be re-used for example in an aqueous emulsion polymerization of one or more fluorinated monomers to produce a fluoropolymer. The method of regenerating the anion exchange resin disclosed in U.S. Pat. No. 4,282,162 involves eluting the resin with a mixture of a mineral acid and an organic solvent in which water can be dissolved such as for example methanol. The method of regenerating the anion exchange resin as disclosed in WO 01/32563 involves eluting a weak basic or medium strong basic anion exchange resin with a mixture of ammonia and a water miscible organic solvent that has a boiling point of less than 150° C. In the method disclosed in EP 1 069 078, the anion exchange resin is eluted with a mixture of water, an ammonium fluoride, ammonium chloride, alkali fluoride or alkali chloride and an organic solvent in which water and the halide can be dissolved. To recover the fluorinated emulsifier from the eluate, the process disclosed in U.S. Pat. No. 5,442,097 can be used.

The invention is further illustrated with reference to the following examples, without however the intention to limit the invention thereto.

### Methods

### Particle Sizes:

Particle sizes of fluoropolymer dispersions may be determined by dynamic light scattering using a Malvern Zetasizer 1000 HSA in according to ISO/DIS13321. Prior to the measurements the polymer latexes were diluted with 0.001 mol/L KCl solution. The measurements are made at 25° C.

### PFOA Content:

The content of fluorinated emulsifier can be measured by gas chromatography (head space), by converting the emulsifier into the methyl ester (using sulfuric acid and methanol) and using the methyl ester of perfluorododecanoic acid as internal standard.

### Solid Content:

The solid content was determined according to ISO 12086 (2 h 120° C., 35 min 380° C.).

### Surfactant Content:

Content of surfactant in the dispersion can be determined by using HPLC. In case of highly concentrated dispersion dilution may be required.

### EXAMPLE 1

### Preparation of a Strong Basic Anion Exchange Resin Charged with Ionic Surfactant

315 ml of a strong basic anion exchange resin (AMBERJET IRA 4200 Cl, commercially available from Rohm & Haas) and 850 g aqueous solution of sodium dodecylsulfate (15% by weight, available from Fluka), were mixed in a rolling bed for six days. The supernatant was analyzed for chloride concentration. The chloride of the anion exchange resins was almost quantitatively replaced by sodium dodecysulphate (>95%).

### EXAMPLE 2

### Preparation of a Weak Basic Anion Exchange Resin Charged with Ionic Surfactant

200 ml of a weak basic anion exchange resin (LEWATIT MP62, commercially available from BAYER AG) and 1,450 g aqueous solution of sodium dodecylsulfate (15% by weight, available from FLUKA), were mixed in a rolling bed for seven days.

### EXAMPLE 3

100 ml of the resin prepared in Example 1 were tranferred into a glass column (length to width ratio of 7 to 1 and washed (equilibrated) with 300 ml dionized water (100 ml/h). A PTFE dispersion having a solid content of 26.8% by weight and an ammonium perfluorooctanoate (APFO) content of 600 ppm was adjusted to pH 3 using diluted (10% wt) sulphuric acid. The dispersion was then passed through the ion-exchange resin from bottom to top with a flow rate of 50 ml/h. A sample taken after 550 ml of dispersion had passed through the column contained 200 ppm APFO. Another sample, taken after 1200 ml dispersion had passed through, had a residual APFO content of 160 ppm. The ion-exchange was stopped and the column was washed with 1000 ml of deionized water. No clogging was observed.

### EXAMPLE 4

100 ml of the resin prepared in Example 1 were tranferred into a glass column as described in example 3 and washed (equilibrated) with 300 ml deionized water (100 ml/h). To a PTFE dispersion having a solid content of 25.3% by weight, an ammonium perfluorooctanoate (APFO) content of 600 ppm and a pH of 9.1, 0.1% by weight, based on the solid content, of a non-ionic emulsifier (GENAPOL X080, available from CLARIANT) was added. The dispersion was then passed through the ion exchange column from bottom to top with a flow rate of 100 ml/h. A sample taken after 500 ml of dispersion had passed through the column contained 170 ppm APFO. Another sample, taken after 800 ml dispersion had passed through, had a residual APFO content of 140 ppm. The ion-exchange was stopped and the column was washed with 1000 ml of deionized water. No clogging was observed.

This example shows that non-ionic surfactants present in the dispersion do not interfere.

### EXAMPLE 5

100 ml of the resin prepared in Example 1 were tranferred into a glass column as described in Example 3 and washed (equilibrated) with 300 ml deionized water (100 ml/h). A THV dispersion having a solid content of 23.2% b weight, an ammonium perfluorooctanoate (APFO) content of 1600 ppm and a pH of 6.2 was passed through the ion exchange column from bottom to top at a flow rate of 100 ml/h. A sample taken after 400 ml of dispersion had passed through the column contained 600 ppm APFO. Another sample, taken after 800 ml dispersion had passed through, had a residual APFO content of 700 ppm. The ion-exchange was stopped and the column was washed with 1000 ml of deionized water. No clogging was observed.

### EXAMPLE 6

100 ml of the resin prepared in Example 2 were tranferred into a glass column as described in Example 3 and washed (equilibrated) with 300 ml deionized water (100 ml/h). A PTFE dispersion having a solid content of 26.8% b weight and an ammonium perfluorooctanoate (APFO) content of 600 ppm was adjusted to pH 6.1.using diluted (10% wt) sulphuric acid. The dispersion was then passed through the ion exchange column from bottom to top with a flow rate of 50 ml/h. A sample taken after 400 ml of dispersion had passed through the column contained 100 ppm APFO. Another sample, taken after 800 ml dispersion had passed through, had also a residual APFO content of 100 ppm. The ion-exchange ws stopped and the column washed with 1000 ml of deionized water. No clogging was observed.

1. A process for reducing the amount of fluorinated emulsifier in a fluoropolymer dispersion, said process comprises contacting the dispersion with an anion exchange resin that has been treated with an ionic surfactant prior to being contacted with the dispersion and wherein the ionic surfactant is either an amphoteric surfactant or an anionic surfactant or a mixture thereof.

2. The process of claim 1 wherein the ionic surfactant is an anionic surfactant having a molecular weight of equal to or less than about 600 g/mol.

3. The process of claim 1 wherein the ionic surfactant is non-aromatic.

4. The process of claim 1 wherein the ionic surfactant contains no more than one anionic group per molecule.

5. The process of claim 1 wherein prior, during or after the ion exchange, the ionic surfactant is added such that the concentration of ionic surfactant in the dispersion after the ion-exchange is at least about 0.02% by weight based on the solid content of the dispersion.

6. The process of claim 1 wherein the fluoropolymer dispersion contains less than 0.5% nonionic surfactants.

7. The process of claim 1 wherein the fluoropolymer dispersion comprises a fluoropolymer having a melting point of less than about 200° C.

8. The process of claim 1 wherein the fluoropolymer dispersion comprises less than 0.5% by weight based on the solid content of the dispersion of non-ionic surfactants.

9. The process of claim 1 wherein the fluoorpolymer dispersion prior to being contacted with the anion exchange resin comprises at least from about 0.02% by weight based on the solid content of the dispersion of fluorinated emulsifier.

10. The process of claim 1 wherein the fluorinated emulsifier corresponds to the general formula (II):
[R_{f}—O-L-COO⁻]ᵢXⁱ⁺ (II)
wherein L represents a linear partially or fully fluorinated alkylene group or an aliphatic hydrocarbon group, R_{f} represents a linear partially or fully fluorinated aliphatic group or a linear partially or fully fluorinated aliphatic group interrupted with one or more oxygen atoms, Xⁱ⁺ represents a cation having the valence i and i is 1, 2 or 3.

11. A process for reducing the amount of fluorinated emulsifier in a fluoropolymer dispersion containing the same, said process comprising contacting the dispersion with an anion exchange resin in the presence of a non-fluorinated ionic surfactant, wherein the ionic surfactant is either an amphoteric surfactant or an anionic surfactant and wherein the ionic surfactant is present in the dispersion, prior to or while the dispersion being contacted with the anion exchange resin, in an amount that exceeds the amount of ionic surfactant that can be taken up by the resin and that is efficient to stabilize the dispersion and wherein the anionic surfactant has a molecular weight of less than about 600 g/mol.

12. The process of claim 11 wherein the contacting the dispersion with the anion exchange resin in the presence of an ionic surfactant involves the use of an anionic exchange resin that has been treated with the ionic surfactant prior to being contacted by the dispersion.

13. An aqueous fluoropolymer dispersion comprising:
i. from about 5% to about 35% by weight based on the weight of the dispersion of a fluoropolymer,
ii. less than about 0.02% by weight based on the solid content of the dispersion of fluorinated emulsifier,
iii. from at least about 0.02% by weight based on the solid content of the dispersion of a non-fluorinated ionic surfactant, wherein the ionic surfactant is an amphoteric surfactant or an anionic surfactant and wherein the anionic surfactant has a molecular weight of less than about 600 g/mol, and
iv. less than about 0.5% by weight based on the solid content of non-ionic surfactants.

14. An aqueous fluoropolymer dispersion comprising:
i. from about 35% to about 70% by weight based on the weight of the dispersion of a
fluoropolymer,
ii. less than about 0.02% by weight based on the solid content of the dispersion of fluorinated emulsifier,
iii. from at least about 0.02% by weight based on the solid content of the dispersion of a non-fluorinated ionic surfactant, wherein the ionic surfactant is an amphoteric surfactant or an anionic surfactant and wherein the anionic surfactant has a molecular weight of less than about 600 g/mol, and
iv. less than about 0.5% by weight based on the solid content of non-ionic surfactants.

15. A coating composition comprising the fluoropolymer dispersion of claims 13 or 14 wherein the coating composition degrades at a temperature below 260° C.

16. An article comprising a first layer comprising the coating composition of claim 15 and a substrate wherein the substrate comprises polyethylene, polypropylene, polyester, paper or glass fabric.

17. An article comprising a first layer comprising the coating composition of claim 15 and a substrate wherein the substrate is a metal surfaces or at least one bearings.
